(19) United States
(12) Patent Application Publication
(10) Pub. No.: US 2005/0184586 A1
(43) Pub. Date: Aug. 25, 2005

(54) Door unlocking method to be implemented using an anti-theft device of an automobile

(76) Inventor: Jeffrey Cheng, Chung-Ho City (TW)

Correspondence Address: CHRISTIE, PARKER & HALE, LLP, PO BOX 7068, PASADENA, CA, 91109-7068, US

(21) Appl. No.: 10/785,567

(22) Filed: Feb. 24, 2004

(51) Int. Cl. B60R 25/00

(52) U.S. Cl. 307/10.2

(57) ABSTRACT

In a door unlocking method that is to be implemented using an anti-theft device of an automobile, a predetermined time period and a predetermined count value are defined. When an interior door lock operates in the locking mode and when the anti-theft device is armed, shaking movements of the automobile are detected. When the detected shaking movements within the predetermined time period match the predetermined count value, the interior door lock is enabled to operate from the locking mode to the unlocking mode, and the anti-theft device is simultaneously disarmed.

### BACKGROUND OF THE INVENTION

1. Field of the Invention

The invention relates to a door unlocking method, more particularly to a door unlocking method to be implemented using an anti-theft device of an automobile.

2. Description of the Related Art

A conventional anti-theft device for an automobile includes a remote controller that is operable so as to control locking and unlocking an interior door lock of the automobile. When the interior door lock is locked, opening of the automobile door is inhibited. On the other hand, when the interior door lock is unlocked, opening of the automobile door is permitted. The interior door lock can be also locked and unlocked with the use of an automobile door key. The remote controller is further operable so as to arm and disarm the conventional anti-theft device.

The conventional anti-theft device is disadvantageous in that when the remote controller and the automobile door key are misplaced, and the interior door lock is left locked, there is no other way for the driver to unlock the interior door lock but to seek assistance from a locksmith. This causes inconveniences, added expense, and waste of time on the part of the driver.

### SUMMARY OF THE INVENTION

Therefore, the object of the present invention is to provide a door unlocking method that permits unlocking of an interior door lock of an automobile by detecting shaking movements of the automobile.

According to one aspect of the present invention, a door unlocking method is implemented using an anti-theft device of an automobile. The automobile includes an automobile door, and an interior door lock mounted on the automobile door. The interior door lock is operable in one of a locking mode, where opening of the automobile door is inhibited, and an unlocking mode, where opening of the automobile door is permitted. The anti-theft device is capable of being armed when the interior door lock operates in the locking mode. The door unlocking method comprises the steps of:
(A) defining a set of predetermined time periods, and a set of predetermined count values corresponding to the set of predetermined time periods;
(B) detecting shaking movements of the automobile when the interior door lock operates in the locking mode; and
(C) enabling operation of the interior door lock from the locking mode to the unlocking mode and simultaneously disarming the anti-theft device when the detected shaking movements within the corresponding set of predetermined time periods match the set of predetermined count values.

According to another aspect of the present invention, there is provided an anti-theft device for an automobile. The automobile includes an automobile door, and an interior door lock mounted on the automobile door. The interior door lock is operable in one of a locking mode, where opening of the automobile door is inhibited, and an unlocking mode, where opening of the automobile door is permitted. The anti-theft device is capable of being armed when the interior door lock operates in the locking mode. The anti-theft device comprises a sensing circuit and a control circuit. The sensing circuit is operable so as to detect shaking movements of the automobile when the anti-theft device is armed. The control circuit is coupled to the sensing circuit, and is adapted to be coupled to the interior door lock. The control circuit enables operation of the interior door lock from the locking mode to the unlocking mode and simultaneously disarms the anti-theft device when the detected shaking movements within a corresponding set of predetermined time periods match a set of predetermined count values.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of an anti-theft device according to the present invention;

FIG. 2 is a plot to illustrate exemplary voltage signals (Vs) generated by a sensing circuit within first and second predetermined time periods (T1, T2); and

FIG. 3 is a flowchart of the preferred embodiment of a door unlocking method to be implemented using the anti-theft device according to the present invention.

### DETAILED DESCRIPTION OF THE PREFERRED EMBODIMENT

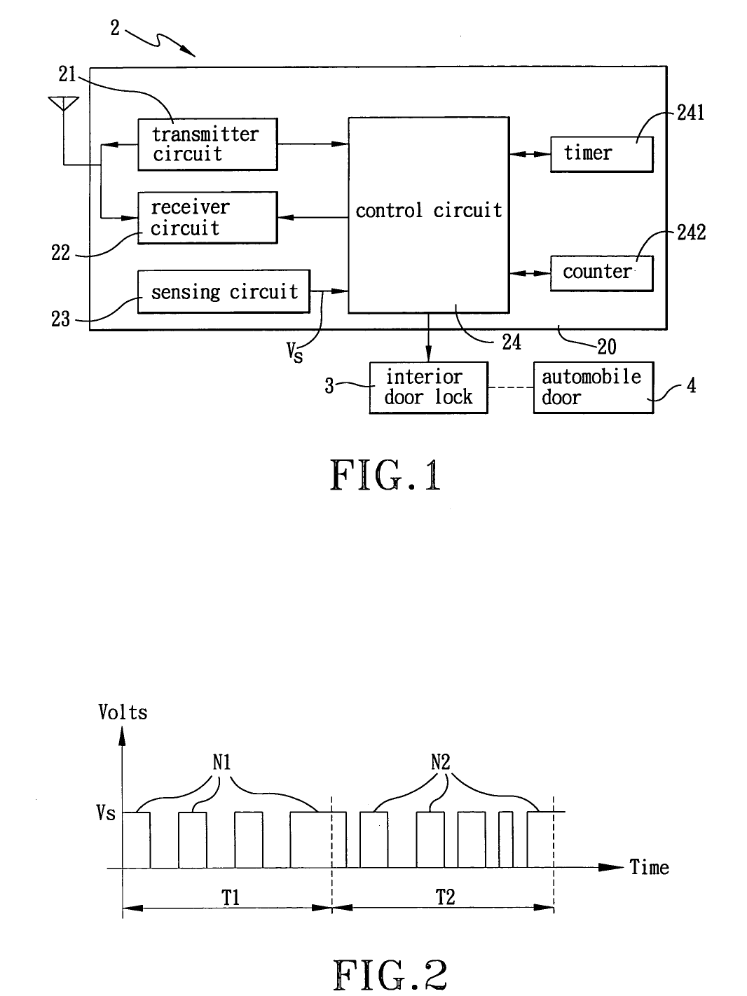

Referring to FIG. 1, the preferred embodiment of an anti-theft device 2 for an automobile according to the present invention is shown to include a sensing circuit 23 and a control circuit 24.

The automobile includes an automobile door 4, and an interior door lock 3 mounted on the automobile door 4. The interior door lock 3 is conventional in construction, and is operable in one of a locking mode, where opening of the automobile door 4 is inhibited, and an unlocking mode, where opening of the automobile door 4 is permitted. It is noted that the anti-theft device 2 is capable of being armed when the interior door lock 3 operates in the locking mode.

The automobile further includes an automobile door key (not shown) that can be used to operated the interior door lock 3 in the locking and unlocking modes, in a known manner.

The anti-theft device 2 further includes a remote controller (not shown) that transmits control signals so as to operate the interior door lock 3 in the locking and unlocking modes and so as to arm and disarm the anti-theft device 2, in a known manner.

The anti-theft device 2 further includes a casing 20, a receiver circuit 22, and a transmitter circuit 21. The receiver circuit 22 is mounted in the casing 20 and is operable so as to receive the control signals from the remote controller. The transmitter circuit 21 is mounted in the casing 20, is coupled to the receiver circuit 22, and is operable so as to transmit acknowledge signals to the remoter controller.

The sensing circuit 23 is mounted in the casing 20. In this embodiment, the sensing circuit 23 is a known vibration sensor that is operable so as to detect shaking movements of the automobile when the anti-theft device 2 is armed, i.e., the interior door lock 3 operates in the locking mode, and so as to generate a voltage signal (Vs) (see FIG. 2) for each detected shaking movement.

The-control circuit 24 is mounted in the casing 20, is coupled to the sensing circuit 23, and is adapted to be coupled to the interior door lock 3. In this embodiment, the control circuit 24 enables operation of the interior door lock 3 from the locking mode to the unlocking mode and simultaneously disarms the anti-theft device 2 when the detected shaking movements within a corresponding set of predetermined time periods match a set of predetermined count values. It is noted that when the detected shaking movements within the corresponding set of predetermined time periods do not match the set of predetermined count values, the control circuit 24 maintains operation of the interior door lock 3 in the locking mode.

With further reference in FIG. 2, the set of predetermined time periods includes first and second predetermined time periods (T1, T2), whereas the set of predetermined count values includes first and second predetermined count values (N1, N2) that correspond respectively to the first and second predetermined time periods (T1, T2). In this embodiment, the first and second predetermined time periods (T1, T2) have equal three-second durations. Furthermore, the first and second predetermined count values (N1, N2) have count values of three and five, respectively. It is noted that the durations of the first and second predetermined time periods (T1, T2), and the count values of the first and second predetermined count values (N1, N2) are factory preset.

The control circuit 24 includes a timer 241 that determines the elapsed time of the first and second predetermined time periods (T1, T2), a counter 242 that cumulatively counts the voltage signals (Vs) generated by the sensing circuit 23 within the first and second predetermined time periods (T1, T2).

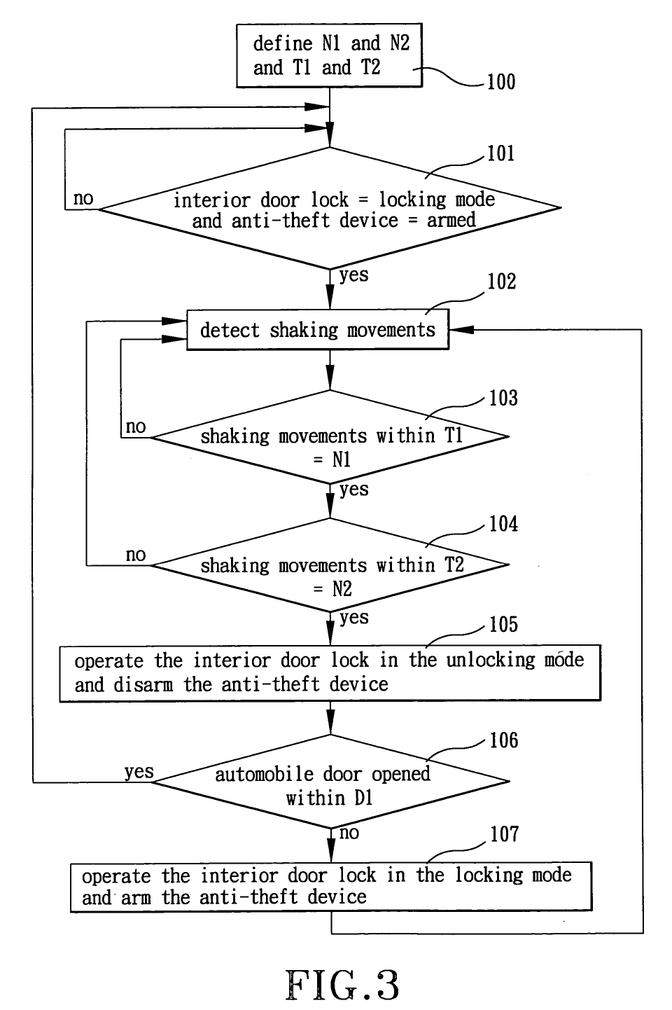

The preferred embodiment of a door unlocking method to be implemented using the anti-theft device 2 includes the steps shown in FIG. 3.

In step 100, the first and second predetermined time periods (T1, T2) and the first and second predetermined count values (N1, N2) are defined.

In step 101, it is determined whether the interior door lock 3 operates in the locking mode and the anti-theft device 2 is armed. If yes, the flow proceeds to step 102. Otherwise, the flow stays in step 101.

In step 102, the sensing circuit 23 detects shaking movements of the automobile. Upon detection, the timer 241 starts timing the first predetermined time period (T1).

In step 103, after the first predetermined time period (T1) has elapsed, the detected number of shaking movements is compared with the first predetermined count value (N1). If a match is detected, the timer 241 starts timing the second predetermined time period (T2) and the flow proceeds to step 104. Otherwise, the flow goes back to step 102.

In step 104, after the second predetermined time period (T2) has elapsed, the detected number of shaking movements is compared to the second predetermined count value (N2). If a match is detected, the flow proceeds to step 105. Otherwise, the flow goes back to step 102.

In step 105, the control circuit 24 enables operation of the interior door lock 3 from the locking mode to the unlocking mode and simultaneously disarms the anti-theft device 2.

In step 106, it is determined whether the automobile door 4 was opened within a predetermined delay time period (D1). If yes, the flow goes back to step 101. Otherwise, the flow proceeds to step 107.

In step 107, the control circuit 24 enables operation of the interior door lock 3 from the unlocking mode back to the locking mode and simultaneously arms the anti-theft device 2. Thereafter, the flow goes back to step 102.

It has thus been shown that the door unlocking method to be implemented using the anti-theft device 2 of the automobile according to the present invention involves the detection of shaking movements of the automobile such that when the detected shaking movements within the corresponding first and second predetermined time periods (T1, T2) match the first and second predetermined count values (N1, N2), respectively, the interior door lock 3 is operated from the locking mode to the unlocking mode and the anti-theft device 2 is simultaneously disarmed. As such, the automobile door 4 can be opened without the use of the remote controller or the automobile door key.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A door unlocking method to be implemented using an anti-theft device of an automobile, the automobile including an automobile door, and an interior door lock mounted on the automobile door, the interior door lock being operable in one of a locking mode, where opening of the automobile door is inhibited, and an unlocking mode, where opening of the automobile door is permitted, the anti-theft device being capable of being armed when the interior door lock operates in the locking mode, said method comprising the steps of:
(A) defining a set of predetermined time periods, and a set of predetermined count values corresponding to the set of predetermined time periods;
(B) detecting shaking movements of the automobile when the interior door lock operates in the locking mode; and
(C) enabling operation of the interior door lock from the locking mode to the unlocking mode and simultaneously disarming the anti-theft device when the detected shaking movements within the corresponding set of predetermined time periods match the set of predetermined count values.

2. The door unlocking method as claimed in claim 1, further comprising the step of maintaining operation of the interior door lock in the locking mode when the detected shaking movements within the corresponding set of predetermined time periods do not match the set of predetermined count values.

3. The door unlocking method as claimed in claim 1, wherein the set of predetermined time periods includes first and second predetermined time periods, whereas the set of predetermined count values includes first and second predetermined count values that correspond respectively to the first and second predetermined time periods.

4. The door unlocking method as claimed in claim 1, further comprising the step of operating the interior door lock from the unlocking mode to the locking mode and simultaneously arming the anti-theft device when the automobile door is not opened within a predetermined delay time period after step (C).

5. An anti-theft device for an automobile, the automobile including an automobile door, and an interior door lock mounted on the automobile door, the interior door lock being operable in one of a locking mode, where opening of the automobile door is inhibited, and an unlocking mode, where opening of the automobile door is permitted, said anti-theft device being armed when the interior door lock operates in the locking mode, and comprising:
a sensing circuit operable so as to detect shaking movements of the automobile when said anti-theft device is armed; and
a control circuit coupled to said sensing circuit, and adapted to be coupled to the interior door lock, said control circuit enabling operation of the interior door lock from the locking mode to the unlocking mode and simultaneously disarming said anti-theft device when the detected shaking movements within a corresponding set of predetermined time periods match a set of predetermined count values.

6. The anti-theft device as claimed in claim 5, wherein said control circuit maintains operation of the interior door lock in the locking mode when the detected shaking movements within the corresponding set of predetermined time periods do not match the set of predetermined count values.

7. The anti-theft device as claimed in claim 5, wherein said sensing circuit is operable so as to generate a voltage signal for each detected shaking movement, said control circuit including
a timer for timing the set of predetermined time periods, and
a counter for cumulatively counting the voltage signals generated by said sensing circuit within the set of predetermined time periods.

8. The anti-theft device as claimed in claim 5, wherein the set of predetermined time periods includes first and second predetermined time periods, whereas the set of predetermined count value includes first and second predetermined count values that correspond respectively to the first and second predetermined time periods.

9. The anti-theft device as claimed in claimed 8, wherein the first predetermined time period has a duration of three seconds.

10. The anti-theft device as claimed in claim 8, wherein the first predetermined count value has a value of three.

11. The anti-theft device as claimed in claim 8, wherein the second predetermined time period has a duration of three seconds.

12. The anti-theft device as claimed in claim 8, the second predetermined count value has a value of five.
